(19) United States
(12) Patent Application Publication
(10) Pub. No.: US 2026/0039706 A1
(43) Pub. Date: Feb. 5, 2026

(54) METHODS, SYSTEMS, AND COMPUTER READABLE MEDIA FOR PROVIDING STREAM CONTROL TRANSMISSION PROTOCOL (SCTP) MULTIHOMING BETWEEN A KUBERNETES ENVIRONMENT AND A NON-KUBERNETES ENVIRONMENT

(71) Applicant: Oracle International Corporation, Redwood Shores, CA (US)

(72) Inventors: Aditya Malaviya, Bengaluru (IN); Parthiban Ethiraj, Bengaluru (IN); Ashutosh Tripathi, Bengaluru (IN); Narayanarao Rednam, Bengaluru (IN)

(21) Appl. No.: 18/794,458

(22) Filed: Aug. 5, 2024

(51) Int. Cl. H04L 65/65; H04L 5/00; H04L 43/10; H04L 69/16

(52) U.S. Cl. CPC H04L 65/65; H04L 5/0055; H04L 43/10; H04L 69/169

(57) ABSTRACT

A method for providing stream control transmission protocol (SCTP) multihoming between a Kubernetes environment and a non-Kubernetes environment includes receiving, at an SCTP multihoming router (SMR) deployed as a pod within the Kubernetes environment and from a client in the non-Kubernetes environment, an SCTP INIT message for establishing a multi-homed SCTP association between first and second Internet protocol (IP) addresses of the client and first and second local IP addresses of the SMR. The first and second local IP addresses of the SMR are added to an SCTP header of the SCTP INIT message. Source and destination network address translations (NATs) are performed to change a source IP address and a destination IP address in an IP header of an IP datagram carrying the SCTP INIT message to a third local IP address of the SMR and a service IP address of a service in the Kubernetes environment, respectively.

### TECHNICAL FIELD

The subject matter described herein relates to stream control transmission protocol (SCTP) multihoming. More specifically, the subject matter relates to methods, systems, and computer readable media for providing SCTP multihoming between a Kubernetes environment and a non-Kubernetes environment.

### BACKGROUND

Multihoming is the ability of an SCTP association to support multiple IP paths to its peer endpoint. The benefit of multihoming associations is that it makes the association more fault-tolerant against physical network failures and other issues on the interfaces. It allows re-routing of packets in the event of failure and provides an alternate path for retransmissions. SCTP offers multihoming feature-enabling connections to utilize multiple internet protocol (IP) paths to peer endpoints.

Kubernetes is an opensource platform for managing containerized workloads and services. Kubernetes is widely used for container orchestration but supporting SCTP multihoming on the client-facing end presents challenges due to limitations in default Kubernetes services. Default Kubernetes services typically support only a single IP path, hindering the implementation of SCTP multihoming. Fault tolerance and reliability made possible by multiple IP paths are crucial in modern networking environments.

Approaches to use multiple IP paths in Kubernetes include using Multus container network interface (CNI) or a host network to attach multiple IPs to a pod. Multus is a meta plug-in, or a CNI plug-in that can run other CNI plug-ins, for attaching multiple network interfaces to pods in Kubernetes. However, these approaches sacrifice load balancing functionality provided by default Kubernetes service objects. This limitation poses challenges for organizations seeking fault-tolerant networking solutions within Kubernetes clusters while maintaining load balancing capabilities.

There is a need for multiple IP paths within a Kubernetes environment that does not sacrifice the default Kubernetes load balancing capabilities.

### SUMMARY

The subject matter relates to methods, systems, and computer readable media for providing SCTP multihoming between a Kubernetes environment and a non-Kubernetes environment. An example method for providing stream control transmission protocol (SCTP) multihoming between a Kubernetes environment and a non-Kubernetes environment includes receiving, at an SCTP multihoming router (SMR) deployed as a pod within the Kubernetes environment and from a client in the non-Kubernetes environment, an SCTP INIT message for establishing a multi-homed SCTP association between first and second Internet protocol (IP) addresses of the client and first and second local IP addresses of the SMR. The method further includes adding, by the SMR, the first and second local IP addresses of the SMR to an SCTP header of the SCTP INIT message. The method further includes performing, by the SMR, source network address translation (NAT) to change a source IP address in an IP header of an IP datagram carrying the SCTP INIT message to a third local IP address of the SMR and destination NAT to change a destination IP address in the IP header of the IP datagram carrying the SCTP INIT message to a service IP address of a service in the Kubernetes environment. The method further includes forwarding, by the SMR, the SCTP INIT message to a connection landing pod associated with the service in the Kubernetes environment.

According to another aspect of the subject matter described herein, the method further includes receiving, at the SMR and from the service IP address, an SCTP INIT-ACK message and performing source NAT to change a source IP address in an IP header of an IP datagram carrying the SCTP INIT-ACK message to the first or second local IP address of the SMR and destination NAT to change a destination IP address in the IP header of the IP datagram carrying the SCTP INIT-ACK message to the first or second IP address of the client.

According to another aspect of the subject matter described herein, the method further includes receiving, at the SMR and from the first IP address of the client, a first heartbeat request and performing source NAT to change a source IP address in an IP header carrying the first heartbeat request to the third local IP address and destination NAT to change a destination IP address in the IP header of the IP datagram carrying the first heartbeat request to the service IP address of the service in the Kubernetes environment.

According to another aspect of the subject matter described herein, the method further includes receiving, at the SMR and from the second IP address of the client, a second heartbeat request and performing source NAT to change a source IP address in an IP header carrying the second heartbeat request to the third local IP address and destination NAT to change a destination IP address in the IP header of the IP datagram carrying the second heartbeat request to the service IP address of the service in the Kubernetes environment.

According to another aspect of the subject matter described herein, the method further includes receiving, at the SMR and from the service IP address of the service in the Kubernetes environment, a first heartbeat acknowledgment message in response to the first heartbeat request and performing source NAT to change a source IP address in an IP header carrying the first heartbeat acknowledgment message to the first local IP address of the SMR and destination NAT to change the destination IP address in the IP header carrying the first heartbeat acknowledgment messages to the first IP address of the client.

According to another aspect of the subject matter described herein, the method further includes receiving, at the SMR and from the service IP address of the service in the Kubernetes environment, a second heartbeat acknowledgment message in response to the second heartbeat request and performing source NAT to change a source IP address in an IP header carrying the second heartbeat acknowledgment message to the second local IP address of the SMR and destination NAT to change the destination IP address in the IP header carrying the second heartbeat acknowledgment messages to the second IP address of the client.

According to another aspect of the method described herein, the first, second, and third local IP addresses of the SMR are IP virtual local area network (IPVLAN) or media access control virtual local area network (MACVLAN) IP addresses.

According to another aspect of the method described herein, the SMR utilizes a container network interface plugin-in to attach to multiple networks.

According to another aspect of the method described herein, the SMR utilizes a stock load balancer in the Kubernetes environment.

An example system for providing stream control transmission protocol (SCTP) multihoming between a Kubernetes environment and a non-Kubernetes environment includes an SCTP multihoming router (SMR) deployed as a pod within a Kubernetes environment and including as least one processor and a memory. The SMR is implemented by the at least one processor for receiving, from a client in the non-Kubernetes environment, an SCTP INIT message for establishing a multi-homed SCTP association between first and second Internet protocol (IP) addresses of the client and first and second local IP addresses of the SMR. The SMR is further configured for adding the first and second local IP addresses of the SMR to an SCTP header of the SCTP INIT message. The SMR is further configured for performing source network address translation (NAT) to change a source IP address in an IP header of an IP datagram carrying the SCTP INIT message to a third local IP address of the SMR and destination NAT to change a destination IP address in the IP header of the IP datagram carrying the SCTP INIT message to a service IP address of a service in the Kubernetes environment. The SMR is further configured for forwarding the SCTP INIT message to a connection landing pod associated with the service in the Kubernetes environment.

According to another aspect of the system described herein, the SMR is configured for receiving, from the service IP address, an SCTP INIT-ACK message and performing source NAT to change a source IP address in an IP header of an IP datagram carrying the SCTP INIT-ACK message to the first or second local IP address of the SMR and destination NAT to change a destination IP address in the IP header of the IP datagram carrying the SCTP INIT-ACK message to the first or second IP address of the client.

According to another aspect of the system described herein, the SMR is configured for receiving, from the first IP address of the client, a first heartbeat request and performing source NAT to change a source IP address in an IP header carrying the first heartbeat request to the third local IP address and destination NAT to change a destination IP address in the IP header of the IP datagram carrying the first heartbeat request to the service IP address of the service in the Kubernetes environment.

According to another aspect of the system described herein, the SMR is configured for receiving, from the second IP address of the client, a second heartbeat request and performing source NAT to change a source IP address in an IP header carrying the second heartbeat request to the third local IP address and destination NAT to change a destination IP address in the IP header of the IP datagram carrying the second heartbeat request to the service IP address of the service in the Kubernetes environment.

According to another aspect of the system described herein, the SMR is configured for receiving, from the service IP address of the service in the Kubernetes environment, a first heartbeat acknowledgment message in response to the first heartbeat request and performing source NAT to change a source IP address in an IP header carrying the first heartbeat acknowledgment message to the first local IP address of the SMR and destination NAT to change the destination IP address in the IP header carrying the first heartbeat acknowledgment messages to the first IP address of the client.

According to another aspect of the system described herein, the SMR is configured for receiving from the service IP address of the service in the Kubernetes environment, a second heartbeat acknowledgment message in response to the second heartbeat request and performing source NAT to change a source IP address in an IP header carrying the second heartbeat acknowledgment message to the second local IP address of the SMR and destination NAT to change the destination IP address in the IP header carrying the second heartbeat acknowledgment messages to the second IP address of the client.

According to another aspect of the system described herein, the first, second, and third local IP addresses of the SMR are IP virtual local area network (IPVLAN) or media access control virtual local area network (MACVLAN) IP addresses.

According to another aspect of the system described herein, the SMR utilizes a container network interface plugin-in to attach to multiple networks.

According to another aspect of the system described herein, the SMR utilizes a stock load balancer in the Kubernetes environment.

An example non-transitory computer readable medium has stored thereon executable instructions that when executed by at least one processor of at least one computer cause the at least one computer to perform steps including receiving, from a client in the non-Kubernetes environment, an SCTP INIT message for establishing a multi-homed SCTP association between first and second Internet protocol (IP) addresses of the client and first and second local IP addresses of the SMR. The steps further include adding the first and second local IP addresses of the SMR to an SCTP header of the SCTP INIT message. The steps further include performing source network address translation (NAT) to change a source IP address in an IP header of an IP datagram carrying the SCTP INIT message to a third local IP address of the SMR and destination NAT to change a destination IP address in the IP header of the IP datagram carrying the SCTP INIT message to a service IP address of a service in the Kubernetes environment. The steps further include forwarding the SCTP INIT message to a connection landing pod associated with the service in the Kubernetes environment.

According to another aspect of the non-transitory computer readable medium described herein, the SMR utilizes a stock load balancer in the Kubernetes environment.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a block diagram illustrating an example system for providing SCTP multihoming between a Kubernetes environment and a non-Kubernetes environment;

FIG. 2 shows a process of association between a client and connection landing pod;

FIG. 3 is an example SCTP header of a message where SMR IPs LIP1 and LIP2 are appended; and

FIG. 4 is a flow diagram illustrating an example method for providing SCTP multihoming between a Kubernetes environment and a non-Kubernetes environment.

### DETAILED DESCRIPTION

The subject matter described herein includes methods, systems, and computer readable media for providing SCTP multihoming between a Kubernetes environment and a non-Kubernetes environment.

A SCTP multihoming router (SMR) can be deployed as a pod within the Kubernetes environment and act as a lightweight router, facilitating SCTP multihomed traffic routing between an external client and Kubernetes connection services/pods. SMR utilizes a CNI plugin-in, such as Multus, to support multiple IPs for SCTP multihoming features. SMR modifies SCTP packet headers and perform source and destination network address translation (NAT) to achieve the needed routing and SCTP multihomed association.

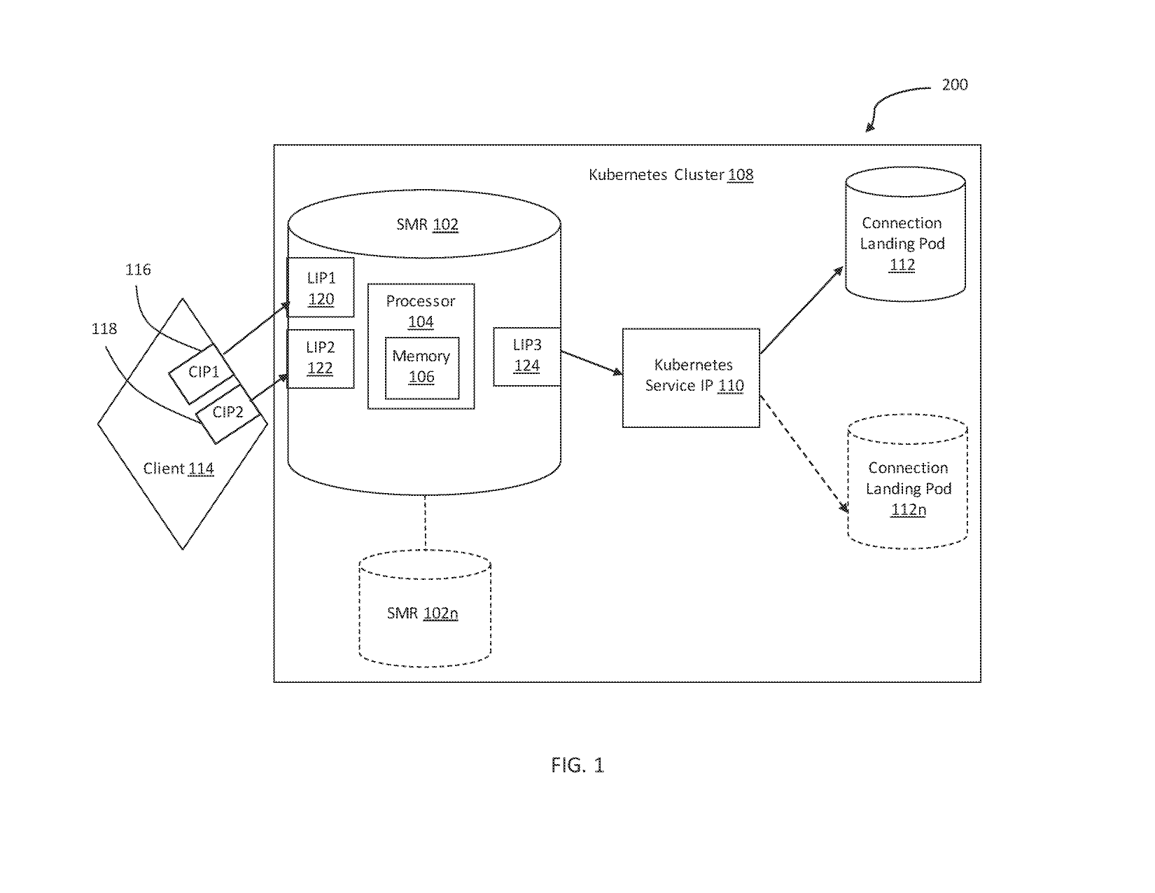

FIG. 1 is a block diagram illustrating an example system 100 for providing SCTP multihoming between a Kubernetes environment and a non-Kubernetes environment. System 100 includes an SMR 102 with at least one processor 104 and memory 106. SMR 102 may include, without limitation, a microcontroller, microprocessor, digital signal processor (DSP) and/or system on a chip (SoC) as described herein. SMR 102, using processor 104 and memory 106, may be configured to perform any of the steps described herein. SMR 102 can act as a lightweight router with a simple configuration and fixed resources to perform NAT and SCTP header manipulation as described herein. SMR 102 can utilize a stock load balancer in the Kubernetes environment.

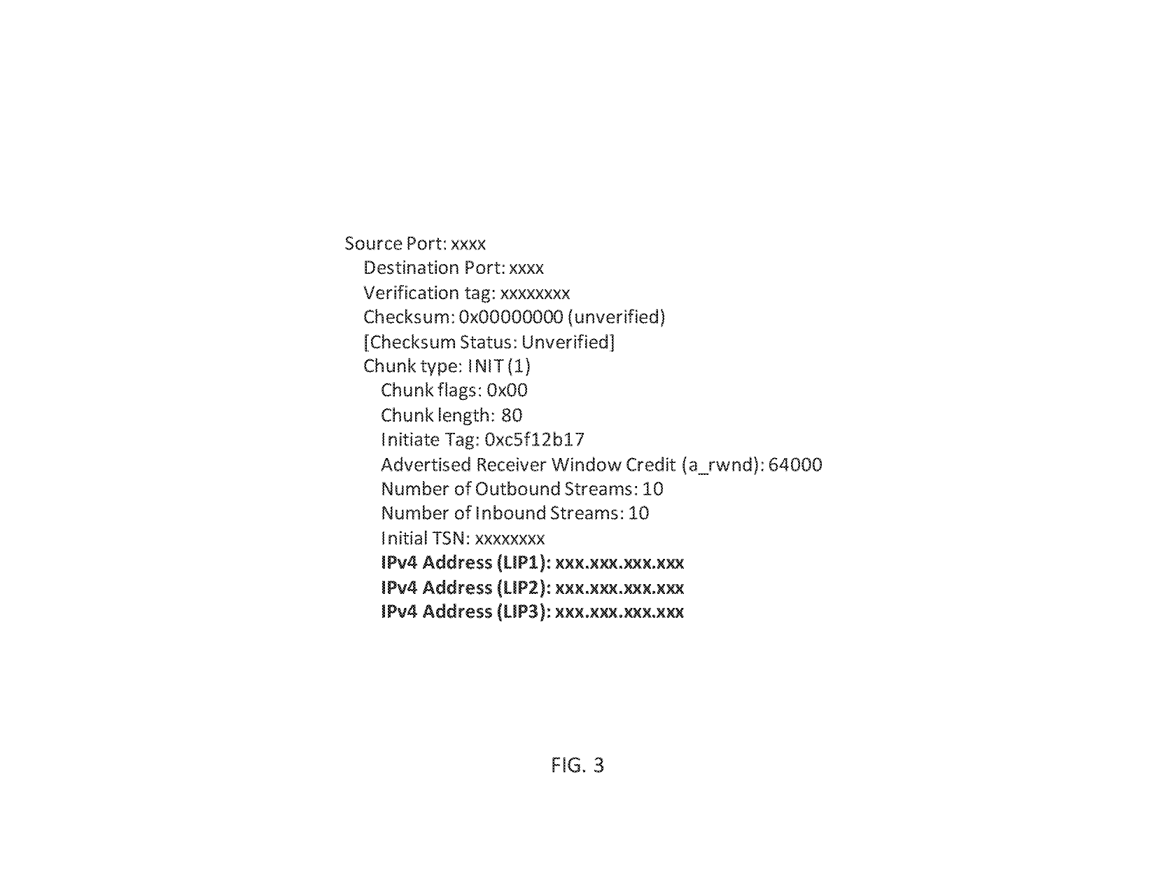

SMR 102 is deployed as a pod within a Kubernetes environment, specifically a Kubernetes cluster 108, along with a Kubernetes service IP 110 that directs communications to and from a connection landing pod 112. SMR 102 can utilize a CNI plugin-in to attach to multiple networks, for example Multus. A client 114 is external to Kubernetes cluster 108 and in a non-Kubernetes environment. Client 114 has multiple local IP addresses, such as first and second local IP addresses referred to herein as CIP1 116 and CIP2118, respectively. Client 114 sends to SMR 102 an SCTP initiation (INIT) message for establishing a multi-homed SCTP association between CIP1 116 and CIP2118 and first and second local IP addresses of SMR 102, referred to herein as LIP1120 and LIP2 122, respectively. SMR 102 receives the SCTP INIT message and adds the first and second local IP addresses of SMR 102 (LIP1120 and LIP2122) to an SCTP header of the SCTP INIT message, as shown in FIG. 3. SMR 102 also performs source NAT to change the source IP address in an IP header of an IP datagram carrying the SCTP INIT to a third local IP address of SMR 102, referred to herein as LIP3 124, and destination NAT to change a destination IP address in the IP header of the IP datagram carrying the SCTP INIT message to Kubernetes service IP 110 address and forwards the INIT message to connection landing pod 112 via Kubernetes service IP 110. LIP3 124 act as a gateway to Kubernetes worker nodes. The local IP addresses of SMR 102, namely LIP1 120, LIP2 122, and LIP3 124, can be IP virtual local area network (IPVLAN) or media access control virtual local area network (MACVLAN) IP addresses. SMR 102 can perform NAT by utilizing, for example, iptables and/or the Extended Berkeley Packet Filter (eBPF).

Connection landing pod 112 responds to the SCTP INIT message, which identifies the source as LIP3 124, by returning an SCTP initiation/acknowledgment (INIT-ACK) message to LIP3124. The SCTP INIT-ACK message includes a state cookie with a Message Authentication Code (MAC) that connection landing pod 112 generates with a secret key, a timestamp corresponding to when the state cookie was created, and any information necessary for establishing the association. SMR 102 then performs source NAT to change a source IP address in an IP header of an IP datagram carrying the SCTP INIT-ACK message to the first or second local IP address of SMR 102, i.e, LIP1 120 or LIP2 122, and destination NAT to change a destination IP address in the IP header of the IP datagram carrying the SCTP INIT-ACK message to the first or second IP address of client 114, i.e, CIP1 116 or CIP2 118.

Client 114 sends a COOKIE-ECHO response that echoes the corresponding state cookie received. Connection landing pod 112 can verify each COOKIE-ECHO response with the secret key, send a COOKIE-ACK for each message, and move each SCTP association to ESTABLISHED state. The SCTP associations between client 114 and connection landing pod 112 are then completed. SMR 102 performs source and destination NAT for COOKIE-ECHO responses in the same manner as performed for the SCTP INIT message. SMR 102 performs source and destination NAT for COOKIE-ACK responses in the same manner as performed for the SCTP INIT-ACK message.

Following the completed SCTP association, client 114 sends a first heartbeat request from CIP1 116 to LIP1 120 and a second heartbeat request from CIP2 118 to LIP2 122. SMR 102 receives the heartbeat requests and performs source and destination NAT on them. This NAT is similar to the NAT that SMR 102 performed on the INIT messages except that these heartbeat requests initially identify LIP1120 and LIP2 122 as destination addresses. In the first heartbeat request from CIP1116, SMR 102 changes the source IP address in an IP header of an IP datagram carrying the first heartbeat request to LIP3 124 and the destination IP address in the IP header from LIP1 120 to Kubernetes service IP 110. In the second heartbeat request from CIP2 118, SMR 102 changes the source IP address in an IP header of an IP datagram carrying the second heartbeat request from CIP2 118 to LIP3 124 and the destination IP address in the IP header from LIP2122 to Kubernetes service IP 110. SMR 102 includes information identifying LIP1120 in the heartbeat request from CIP1 116 and information identifying LIP2 122 in the heartbeat request from CIP2 118. SMR 102 forwards the revised heartbeat requests to connection landing pod 112 via Kubernetes service IP 110.

Connection landing pod 112 sends first and second heartbeat acknowledgment messages responsive to first and second heartbeat requests, respectively, to SMR 102, specifically LIP3 124, via Kubernetes service IP 110. SMR 102 performs source and destination NAT on the heartbeat acknowledgement messages. SMR 102 performs source and destination NAT on the heartbeat acknowledgment messages. SMR 102 changes in the first heartbeat acknowledgment message the source IP address in an IP header of an IP datagram carrying the first heartbeat acknowledgment message from Kubernetes service IP 110 to LIP1120 and the destination IP address in the IP header from LIP3124 to CIP1116. SMR 102 changes in the second heartbeat acknowledgment message the source IP address in an IP header of an IP datagram carrying the second heartbeat acknowledgment message from Kubernetes service IP 110 to LIP2122 and the destination IP address in the IP header from LIP3124 to CIP2118. SMR 102 forwards the updated heartbeat acknowledgment messages to CIP1116 and CIP2 118, respectively.

LIP1 120 and LIP2 122 provide physical path redundancy in case an interface between client 114 and Kubernetes cluster 108 fails. As SMR 102 provides SCTP association for client 114 on two IP addresses where LIP1120 provides a primary interface and LIP2122 provides a secondary interface, SMR 102 allows for IP traffic using LIP1120 to failover to LIP2 122 when LIP1 120 fails. Incoming or ingress traffic from client 144 to Kubernetes cluster 108 and outgoing or egress traffic from Kubernetes cluster 108 to client can all failover to LIP2 122.

SMR 102 performs source and destination NAT on incoming messages from client 114 to connection landing pod 112 in the same manner as described for the heartbeat requests. Specifically, the source IP address in an IP header of a IP datagram carrying the incoming message is changed from CIP1116 or CIP2 118 (depending on which client IP address sent the message) to LIP3124 and the destination IP address is changed from LIP1/LIP2 (depending on which SMR IP address received the message) to Kubernetes service IP 110. SMR 102 performs source and destination NAT on outgoing messages from connection landing pod 112 to client 114 in the same manner as described for the heartbeat acknowledgment messages. Specifically the source IP address in an IP header of a IP datagram carrying the outgoing message is changed from Kubernetes service IP 110 to LIP1 120 or LIP2 122 (depending on whether the message is intended for CIP1116 or CIP2 118, respectively) and the destination IP address is changed from LIP3124 to CIP1 116 or CIP2 118. SMR 102 can also manipulate the SCTP header of the messages it forwards by including LIP1, LIP2, and/or LIP3 information as described herein. It is understood that SMR 102 is configured for closing active SCTP associations by utilizing the source and destination NAT and SCTP header manipulation described herein.

SMR 102 allows for the native Kubernetes service mesh to be used for distributing SCTP loads to backend connection pods. SMR 102 can also be implemented as an external load balancer for Kubernetes with additional features. In some aspects of the described subject matter, system 100 can utilize Kubernetes v1.26.5 or above, Kernel UEK 5.15 or above, and/or Istio with Destination Rules for communication between SMR 102 and Kubernetes service IP 110 for connection.

It is understood that system 100 is scalable and can include a plurality of SMRs deployed as pods in Kubernetes cluster 108, such as SMR 102n, that includes the same features as described for SMR 112 and provide SCTP multihoming between a Kubernetes environment and a non-Kubernetes environment. Similarly, Kubernetes cluster 108 can include a plurality of Kubernetes servers, such as connection landing pod 112n, which include the same features as described for connection landing pod 112 and share Kubernetes service IP 110 with connection landing pod 112 to receive and transmit messages and/or utilize a separate Kubernetes server within Kubernetes cluster 108.

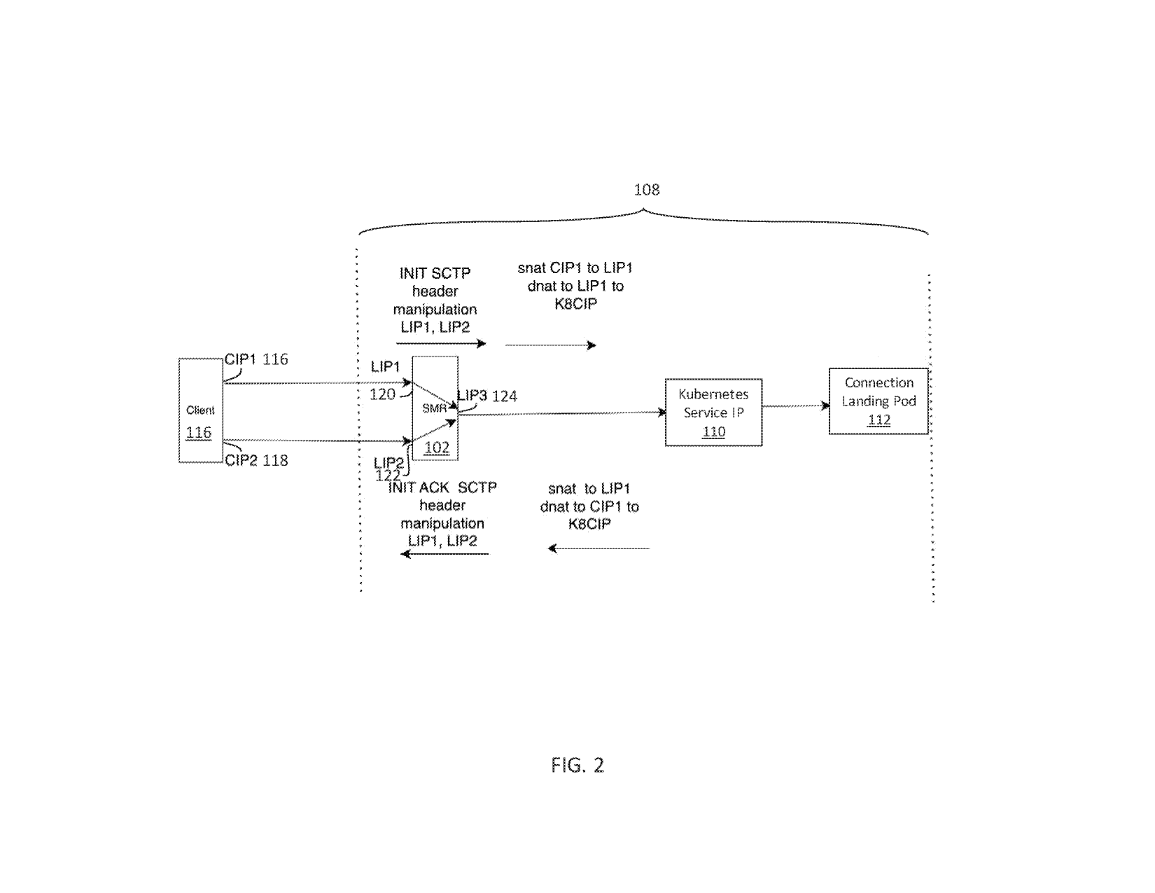

FIG. 2 shows a process of association between client 114 and connection landing pod 112. Client 114 sends an SCTP INIT message for establishing a multi-homed SCTP association between CIP1116 and LIP1120 and between CIP2118 and LIP2122. SMR 102 receives the SCTP INIT message and manipulates the SCTP header in the SCTP INIT message to include the first and second local IP addresses of SMR 102, namely LIP1 120 and LIP2 122, and revises the source and destination IP addresses in an IP header of an IP datagram carrying the SCTP INIT message to LIP3 124 and Kubernetes service IP 110, respectively. Kubernetes service IP 110 forwards the SCTP INIT message to connection landing pod 112, which responds to the SCTP INIT message with an SCTP INIT-ACK message with LIP3124 as the destination IP address. SMR 102 performs source and destination NAT to change the source and destination IP addresses to LIP1120 and CIP1 116, respectively, or to LIP2122 and CIP2118, respectively.

FIG. 3 is an example SCTP header of a message where SMR IPs LIP1, LIP2, and LIP3 are appended. SMR 102, as shown in FIG. 1, can append one or all of its IP addresses to messages before forwarding, such as SCTP INIT messages received from the client, SCTP INIT-ACK messages to the client, and incoming and outgoing messages after the SCTP association. For example, in an SCTP INIT message or an incoming message after SCTP association that SMR 102 performs source NAT on and changes the source IP address to LIP3, SMR 102 may append only the original source IP address, i.e., CIP1 in the message was received from CIP1 or CIP2 if the message was received from CIP2.

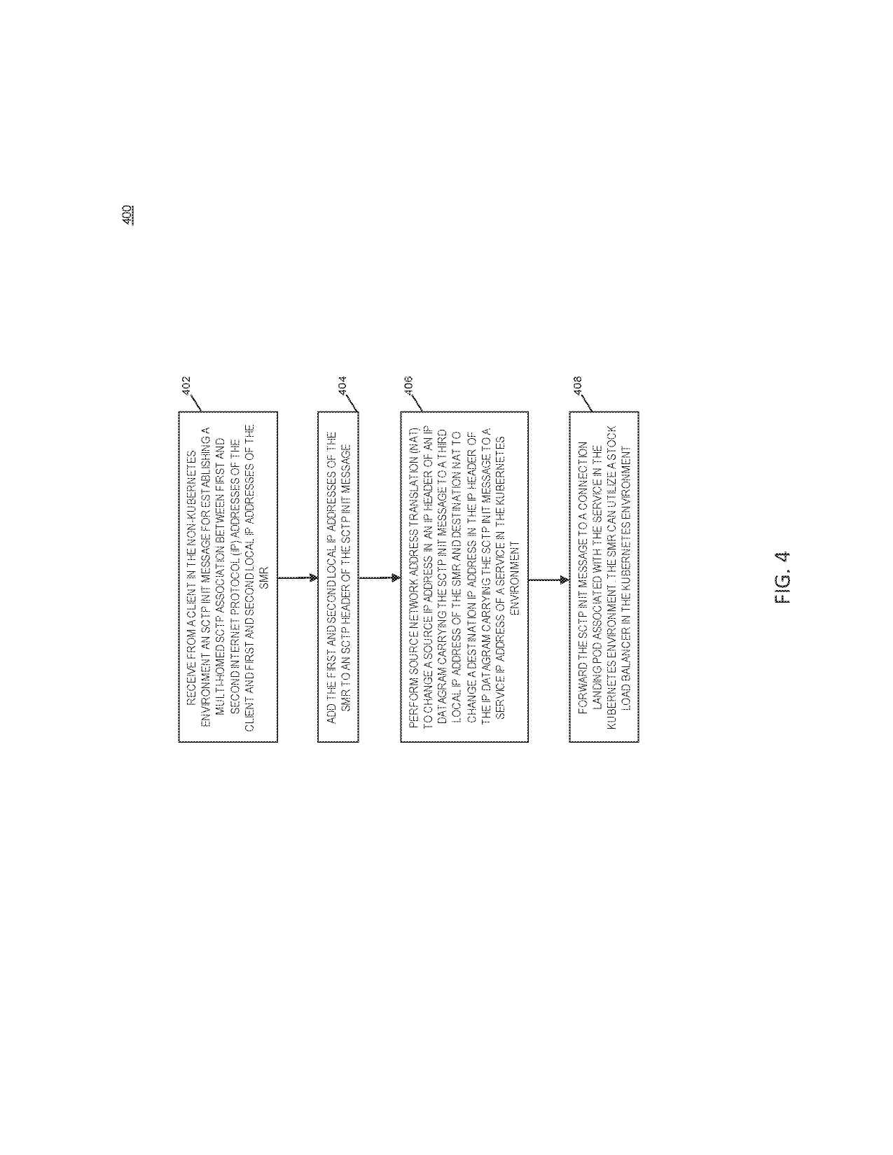

FIG. 4 shows a flow diagram illustrating an example method for providing SCTP multihoming between a Kubernetes environment and a non-Kubernetes environment. At step 402, an SCTP multihoming router (SMR) deployed as a pod within the Kubernetes environment receives from a client in the non-Kubernetes environment an SCTP INIT message for establishing a multi-homed SCTP association between first and second Internet protocol (IP) addresses of the client and first and second local IP addresses of the SMR. The SMR can utilize a container network interface plugin-in to attach to multiple networks.

At step 404, the SMR adds the first and second local IP addresses of the SMR to an SCTP header of the SCTP INIT message.

At step 406, the SMR performs source network address translation (NAT) to change a source IP address in an IP header of an IP datagram carrying the SCTP INIT message to a third local IP address of the SMR and destination NAT to change a destination IP address in the IP header of the IP datagram carrying the SCTP INIT message to a service IP address of a service in the Kubernetes environment. The first, second, and third local IP addresses of the SMR can be IP virtual local area network (IPVLAN) or media access control virtual local area network (MACVLAN) IP addresses.

At step 408, the SMR forwards the SCTP INIT message to a connection landing pod associated with the service in the Kubernetes environment. The SMR can utilize a stock load balancer in the Kubernetes environment.

Method 400 can further include receiving, at the SMR and from the service IP address, an SCTP INIT-ACK message and performing source NAT to change a source IP address in an IP header of an IP datagram carrying the SCTP INIT-ACK message to the first or second local IP address of the SMR and destination NAT to change a destination IP address in the IP header of the IP datagram carrying the SCTP INIT-ACK message to the first or second IP address of the client.

Method 400 can further include receiving, at the SMR and from the first IP address of the client, a first heartbeat request and performing source NAT to change a source IP address in an IP header carrying the first heartbeat request to the third local IP address and destination NAT to change a destination IP address in the IP header of the IP datagram carrying the first heartbeat request to the service IP address of the service in the Kubernetes environment.

Method 400 can further include receiving, at the SMR and from the second IP address of the client, a second heartbeat request and performing source NAT to change a source IP address in an IP header carrying the second heartbeat request to the third local IP address and destination NAT to change a destination IP address in the IP header of the IP datagram carrying the second heartbeat request to the service IP address of the service in the Kubernetes environment.

Method 400 can further include receiving, at the SMR and from the service IP address of the service in the Kubernetes environment, a first heartbeat acknowledgment message in response to the first heartbeat request and performing source NAT to change a source IP address in an IP header carrying the first heartbeat acknowledgment message to the first local IP address of the SMR and destination NAT to change the destination IP address in the IP header carrying the first heartbeat acknowledgment messages to the first IP address of the client.

Method 400 can further include receiving, at the SMR and from the service IP address of the service in the Kubernetes environment, a second heartbeat acknowledgment message in response to the second heartbeat request and performing source NAT to change a source IP address in an IP header carrying the second heartbeat acknowledgment message to the second local IP address of the SMR and destination NAT to change the destination IP address in the IP header carrying the second heartbeat acknowledgment messages to the second IP address of the client.

It will be appreciated that method 400 is for illustrative purposes and that different and/or additional actions may be used. It will also be appreciated that various actions described herein may occur in a different order or sequence. It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

The disclosure of each of the following references is hereby incorporated by reference in its entirety.

### References

Park, Daein, Multus CNI using Ipvlan plug-in for multiple networks in OpenShift, Medium, https://daein.medium.com/multus-cni-using-ipvlan-plug-in-for-multiple-networks-in-openshift-4087ba63b276 (Feb. 16, 2021).

Multihoming. Oracle. https://docs.oracle.com/cd/E57516_01/docs.70/Transport _Manager/concepts/c_transport_mgr_multihoming.html.

Services. Kubernetes. https://kubernetes.io/docs/concepts/services-networking/service/ (June 25, 2024).

What is claimed is:

1. A method for providing stream control transmission protocol (SCTP) multihoming between a Kubernetes environment and a non-Kubernetes environment, the method comprising:
receiving, at an SCTP multihoming router (SMR) deployed as a pod within the Kubernetes environment and from a client in the non-Kubernetes environment, an SCTP INIT message for establishing a multi-homed SCTP association between first and second Internet protocol (IP) addresses of the client and first and second local IP addresses of the SMR;
adding, by the SMR, the first and second local IP addresses of the SMR to an SCTP header of the SCTP INIT message;
performing, by the SMR, source network address translation (NAT) to change a source IP address in an IP header of an IP datagram carrying the SCTP INIT message to a third local IP address of the SMR and destination NAT to change a destination IP address in the IP header of the IP datagram carrying the SCTP INIT message to a service IP address of a service in the Kubernetes environment; and
forwarding, by the SMR, the SCTP INIT message to a connection landing pod associated with the service in the Kubernetes environment.

2. The method of claim 1, comprising receiving, at the SMR and from the service IP address, an SCTP INIT-ACK message and performing source NAT to change a source IP address in an IP header of an IP datagram carrying the SCTP INIT-ACK message to the first or second local IP address of the SMR and destination NAT to change a destination IP address in the IP header of the IP datagram carrying the SCTP INIT-ACK message to the first or second IP address of the client.

3. The method of claim 1, comprising receiving, at the SMR and from the first IP address of the client, a first heartbeat request and performing source NAT to change a source IP address in an IP header carrying the first heartbeat request to the third local IP address and destination NAT to change a destination IP address in the IP header of the IP datagram carrying the first heartbeat request to the service IP address of the service in the Kubernetes environment.

4. The method of claim 3, comprising receiving, at the SMR and from the second IP address of the client, a second heartbeat request and performing source NAT to change a source IP address in an IP header carrying the second heartbeat request to the third local IP address and destination NAT to change a destination IP address in the IP header of the IP datagram carrying the second heartbeat request to the service IP address of the service in the Kubernetes environment.

5. The method of claim 4, comprising receiving, at the SMR and from the service IP address of the service in the Kubernetes environment, a first heartbeat acknowledgment message in response to the first heartbeat request and performing source NAT to change a source IP address in an IP header carrying the first heartbeat acknowledgment message to the first local IP address of the SMR and destination NAT to change the destination IP address in the IP header carrying the first heartbeat acknowledgment messages to the first IP address of the client.

6. The method of claim 5, comprising receiving, at the SMR and from the service IP address of the service in the Kubernetes environment, a second heartbeat acknowledgment message in response to the second heartbeat request and performing source NAT to change a source IP address in an IP header carrying the second heartbeat acknowledgment message to the second local IP address of the SMR and destination NAT to change the destination IP address in the IP header carrying the second heartbeat acknowledgment messages to the second IP address of the client.

7. The method of claim 1, wherein the first, second, and third local IP addresses of the SMR are IP virtual local area network (IPVLAN) or media access control virtual local area network (MACVLAN) IP addresses.

8. The method of claim 1, wherein the SMR utilizes a container network interface plugin-in to attach to multiple networks.

9. The method of claim 1, wherein the SMR utilizes a stock load balancer in the Kubernetes environment.

10. A system for providing stream control transmission protocol (SCTP) multihoming between a Kubernetes environment and a non-Kubernetes environment, the system comprising:
an SCTP multihoming router (SMR) deployed as a pod within a Kubernetes environment and including as least one processor and a memory, the SMR implemented by the at least one processor for:
receiving, from a client in the non-Kubernetes environment, an SCTP INIT message for establishing a multi-homed SCTP association between first and second Internet protocol (IP) addresses of the client and first and second local IP addresses of the SMR;
adding the first and second local IP addresses of the SMR to an SCTP header of the SCTP INIT message;
performing source network address translation (NAT) to change a source IP address in an IP header of an IP datagram carrying the SCTP INIT message to a third local IP address of the SMR and destination NAT to change a destination IP address in the IP header of the IP datagram carrying the SCTP INIT message to a service IP address of a service in the Kubernetes environment; and
forwarding the SCTP INIT message to a connection landing pod associated with the service in the Kubernetes environment.

11. The system of claim 10, wherein the SMR is configured for receiving, from the service IP address, an SCTP INIT-ACK message and performing source NAT to change a source IP address in an IP header of an IP datagram carrying the SCTP INIT-ACK message to the first or second local IP address of the SMR and destination NAT to change a destination IP address in the IP header of the IP datagram carrying the SCTP INIT-ACK message to the first or second IP address of the client.

12. The system of claim 10, wherein the SMR is configured for receiving, from the first IP address of the client, a first heartbeat request and performing source NAT to change a source IP address in an IP header carrying the first heartbeat request to the third local IP address and destination NAT to change a destination IP address in the IP header of the IP datagram carrying the first heartbeat request to the service IP address of the service in the Kubernetes environment.

13. The system of claim 12, wherein the SMR is configured for receiving, from the second IP address of the client, a second heartbeat request and performing source NAT to change a source IP address in an IP header carrying the second heartbeat request to the third local IP address and destination NAT to change a destination IP address in the IP header of the IP datagram carrying the second heartbeat request to the service IP address of the service in the Kubernetes environment.

14. The system of claim 13, wherein the SMR is configured for receiving, from the service IP address of the service in the Kubernetes environment, a first heartbeat acknowledgment message in response to the first heartbeat request and performing source NAT to change a source IP address in an IP header carrying the first heartbeat acknowledgment message to the first local IP address of the SMR and destination NAT to change the destination IP address in the IP header carrying the first heartbeat acknowledgment messages to the first IP address of the client.

15. The system of claim 14, wherein the SMR is configured for receiving from the service IP address of the service in the Kubernetes environment, a second heartbeat acknowledgment message in response to the second heartbeat request and performing source NAT to change a source IP address in an IP header carrying the second heartbeat acknowledgment message to the second local IP address of the SMR and destination NAT to change the destination IP address in the IP header carrying the second heartbeat acknowledgment messages to the second IP address of the client.

16. The system of claim 10, wherein the first, second, and third local IP addresses of the SMR are IP virtual local area network (IPVLAN) or media access control virtual local area network (MACVLAN) IP addresses.

17. The system of claim 10, wherein the SMR utilizes a container network interface plugin-in to attach to multiple networks.

18. The system of claim 10, wherein the SMR utilizes a stock load balancer in the Kubernetes environment.

19. A non-transitory computer readable medium having stored thereon executable instructions that when executed by at least one processor of at least one computer cause the at least one computer to perform steps comprising:
receiving, from a client in the non-Kubernetes environment, an SCTP INIT message for establishing a multi-homed SCTP association between first and second Internet protocol (IP) addresses of the client and first and second local IP addresses of the SMR;
adding the first and second local IP addresses of the SMR to an SCTP header of the SCTP INIT message;
performing source network address translation (NAT) to change a source IP address in an IP header of an IP datagram carrying the SCTP INIT message to a third local IP address of the SMR and destination NAT to change a destination IP address in the IP header of the IP datagram carrying the SCTP INIT message to a service IP address of a service in the Kubernetes environment; and
forwarding the SCTP INIT message to a connection landing pod associated with the service in the Kubernetes environment.

20. The non-transitory computer readable medium of claim 19, wherein the SMR utilizes a stock load balancer in the Kubernetes environment.
